(19) United States
(12) Patent Application Publication
(10) Pub. No.: US 2021/0192552 A1
(43) Pub. Date: Jun. 24, 2021

(54) CLOTHING DESIGN ATTRIBUTE IDENTIFICATION FOR GEOGRAPHICAL REGIONS

(71) Applicant: International Business Machines Corporation, Armonk, NY (US)

(72) Inventors: Akshay Gugnani, New Delhi (IN); Vikas Chandrakant Raykar, Bangalore (IN); Vijay Ekambaram, Chennai (IN); Amith Singhee, Bangalore (IN); Surya Shravan Kumar Sajja, Bangalore (IN)

(21) Appl. No.: 16/718,793

(22) Filed: Dec. 18, 2019

(51) Int. Cl. G06Q 30/02; G06Q 30/06; G06F 40/30

(52) U.S. Cl. CPC G06Q 30/0205; G06Q 30/0201; G06F 40/30; G06Q 30/0282; G06Q 30/0631

(57) ABSTRACT

One embodiment provides a method, including: receiving a clothing design, wherein the clothing design identifies attributes of an article of clothing; accessing a plurality of information sources having sentiments regarding attributes of pieces of clothing, wherein each of the plurality of information sources is assigned to one of a plurality of geographical regions; identifying location-dependent attributes of the pieces of clothing, wherein the location-dependent attributes comprise clothing attributes whose corresponding user sentiments vary across at least a subset of the geographical regions; and recommending, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

### BACKGROUND

Articles of clothing having similar designs are sold across many different geographical regions. For example, a person can find similar button-up shirts in many different geographical regions. However, some characteristics of the clothing (e.g., fabric type, characteristic size, fabric color, clothing fit, fabric design, etc.) are more favorably received in some geographical regions as opposed to other geographical regions. For example, in one geographical region, stripes may be popular, while polka-dots are preferred over stripes in a different geographical region. In order to increase sales, clothing designers take into account the different preferences in different target geographical regions. Using the above example, the clothing designer may offer the button-up shirt in a striped fabric in a geographical region having a preference for stripes. The clothing designer may also offer the button-up shirt in a polka-dot fabric for sale in a geographical region having a preference for polka-dots. Even though the fabric design in the two geographical regions is different, the general design for the button-up shirt remains similar in both geographical regions.

### BRIEF SUMMARY

In summary, one aspect of the invention provides a method, comprising: receiving a clothing design, wherein the clothing design identifies attributes of an article of clothing; accessing a plurality of information sources having sentiments regarding attributes of pieces of clothing, wherein each of the plurality of information sources has a corresponding geographical location associated with the sentiment, wherein each of the plurality of information sources is assigned to one of a plurality of geographical regions; identifying, utilizing the plurality of information sources corresponding to respective assigned geographical regions, location-dependent attributes of the pieces of clothing, wherein the location-dependent attributes comprise clothing attributes whose corresponding user sentiments vary across at least a subset of the geographical regions; and recommending, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

Another aspect of the invention provides an apparatus, comprising: at least one processor; and a computer readable storage medium having computer readable program code embodied therewith and executable by the at least one processor, the computer readable program code comprising: computer readable program code configured to receive a clothing design, wherein the clothing design identifies attributes of an article of clothing; computer readable program code configured to access a plurality of information sources having sentiments regarding attributes of pieces of clothing, wherein each of the plurality of information sources has a corresponding geographical location associated with the sentiment, wherein each of the plurality of information sources is assigned to one of a plurality of geographical regions; computer readable program code configured to identify, utilizing the plurality of information sources corresponding to respective assigned geographical regions, location-dependent attributes of the pieces of clothing, wherein the location-dependent attributes comprise clothing attributes whose corresponding user sentiments vary across at least a subset of the geographical regions; and computer readable program code configured to recommend, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

An additional aspect of the invention provides a computer program product, comprising: a computer readable storage medium having computer readable program code embodied therewith, the computer readable program code executable by a processor and comprising: computer readable program code configured to receive a clothing design, wherein the clothing design identifies attributes of an article of clothing; computer readable program code configured to access a plurality of information sources having sentiments regarding attributes of pieces of clothing, wherein each of the plurality of information sources has a corresponding geographical location associated with the sentiment, wherein each of the plurality of information sources is assigned to one of a plurality of geographical regions; computer readable program code configured to identify, utilizing the plurality of information sources corresponding to respective assigned geographical regions, location-dependent attributes of the pieces of clothing, wherein the location-dependent attributes comprise clothing attributes whose corresponding user sentiments vary across at least a subset of the geographical regions; and computer readable program code configured to recommend, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

A further aspect of the invention provides a method, comprising: receiving input related to a clothing design, wherein the input identifies characteristics of the clothing design; accessing reviews of customers corresponding to the clothing design, wherein each of the reviews identifies at least one sentiment of a user providing the review regarding a characteristic of the clothing design, wherein each of the reviews is associated with a geographical location of the user providing the review and wherein the reviews are grouped into geographical areas based upon the geographical location associated with the reviews; identifying (i) prominent characteristics of the clothing design and (ii) location-dependent characteristics of the clothing design; wherein the identifying prominent characteristics comprises identifying characteristics of the clothing design (iii) whose corresponding user sentiments have a variation in sentiment below a predetermined threshold between geographical areas and (iv) include characteristics critical to the clothing design; wherein the identifying location-dependent characteristics comprises identifying characteristics of the clothing design (v) whose corresponding user sentiments within one geographical area vary from corresponding user sentiments within a different geographical area and (vi) that are not critical characteristics to the clothing design; and recommending an attribute value for the location-dependent characteristics based upon attribute values having a positive sentiment within a targeted geographical area in which the clothing design is to be sold

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of recommending parameter values for attributes of a clothing design based upon the geographical region in which the clothing design is introduced, by identifying location-dependent characteristics of the clothing design.

FIG. 2 illustrates an example system architecture for recommending parameter values for attributes of a clothing design based upon the geographical region in which the clothing design is introduced, by identifying location-dependent characteristics of the clothing design.

FIG. 3 illustrates an example method for identification of focus and non-focus attributes.

FIG. 4 illustrates an example method for identification of location-dependent attributes.

FIG. 5 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

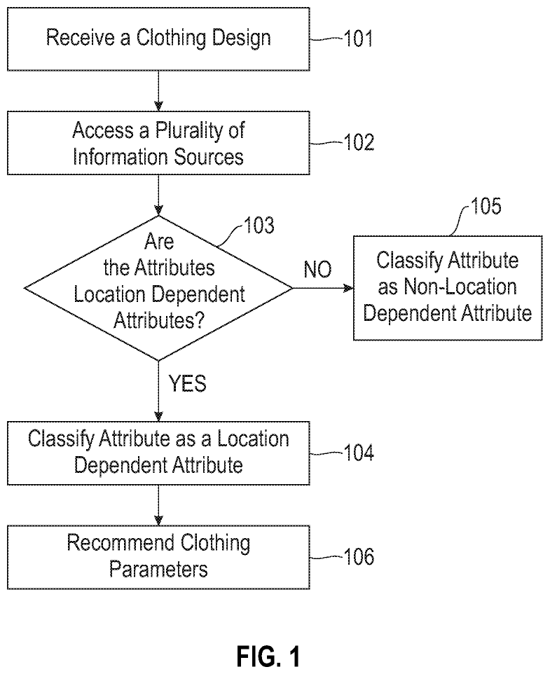

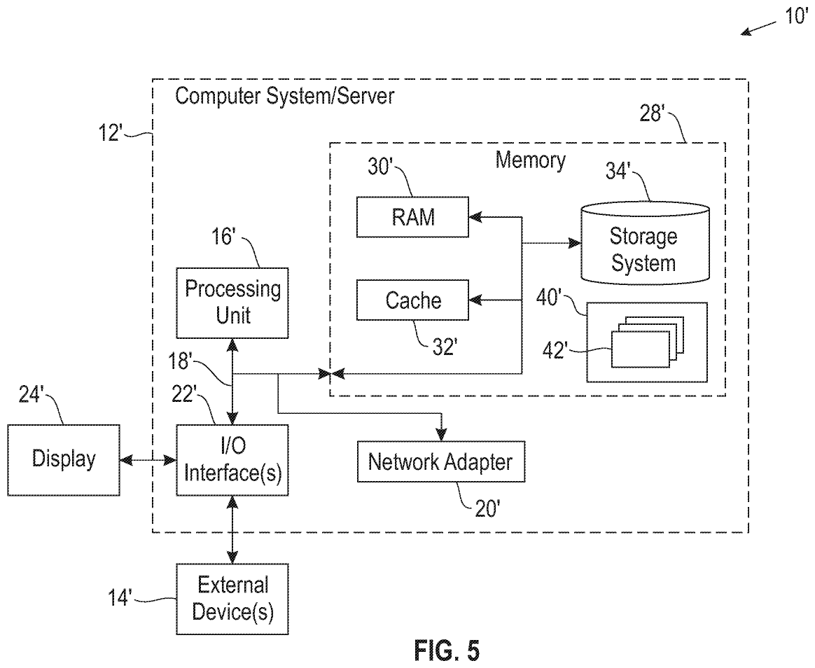

Specific reference will be made here below to FIGS. 1-5. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 5. In accordance with an example embodiment, most if not all of the process steps, components and outputs discussed with respect to FIGS. 1-4 can be performed or utilized by way of a processing unit or units and system memory such as those indicated, respectively, at 16′ and 28′ in FIG. 5, whether on a server computer, a client computer, a node computer in a distributed network, or any combination thereof

Currently fashion designers and clothing manufacturers must have an idea of the preferences that a particular geographical region has with respect to various clothing characteristics. However, not all designers or clothing manufacturers may know exactly what will be well received within a particular geographical region, particularly if the clothing design is a brand new design. For example, button-up shirts may be a clothing staple, and therefore, the characteristics that will be popular may be easier to determine. On the other hand, with a brand new design for a special occasion dress, the characteristics that will be popular may not be as readily apparent. Additionally, preferences for particular characteristics may change over time, thereby making any previous knowledge of the popular clothing characteristics obsolete. Additionally, not all clothing characteristics may be suitable for a particular clothing design. For example, while a floral pattern may be popular for a shirt or skirt, the same floral pattern may not be as well received for a pair of trousers. As another example, a large cuff on a dress shirt may be popular, whereas the same large cuff on a casual shirt may not be as popular. Thus, it is currently difficult for clothing designers and manufacturers to identify clothing characteristics that would result in desirable sales within a particular geographical region. Rather, the conventional techniques rely on human knowledge of the geographical region and preferences within that geographical region.

Accordingly, an embodiment provides a system and method for recommending parameter values for attributes of a clothing design based upon the geographical region in which the clothing design is introduced, by identifying location-dependent characteristics of the clothing design. The system receives a clothing design that identifies attributes for an article of clothing for production or sale. For example, the system may receive design images, a design description, communications regarding the design, or the like. The system can parse this information to identify different attributes of the article of clothing (e.g., article type, fabric type, component sizes, fabric color, design elements, etc.).

Additionally, the system receives or accesses a plurality of information sources that include sentiments of users regarding different attributes of pieces of clothing. For example, the system may access reviews provided by buyers of clothing pieces, social media posts of people wearing clothing pieces, fashion review articles, designer interviews, and the like. The information sources may be sources that are directed toward the target article of clothing, for example, a review of a fashion show featuring the target article of clothing, or sources that are directed toward other pieces of clothing that may have attributes similar to those of the target article of clothing. Each of the information sources includes a corresponding geographical location, for example, the physical location of the user providing the information source. This allows the system to group the information sources into geographical regions or areas.

From the information sources, and particularly the information sources that are within a geographical region group, the system can identify different location-dependent attributes, which are those attributes whose parameter value varies across different geographical regions. For example, if the attribute is fabric design, different attribute values may include stripes, polka-dots, floral, solid, and the like. To determine that the parameter value varies, the system analyzes the sentiment of the users within the geographical region with respect to the attribute value. Positive sentiments may indicate that the people of that geographical region like that attribute value and would be willing to purchase an article of clothing having that attribute value. On the other hand, negative sentiments may indicate that the people of that geographical region do not like that attribute value and would not purchase an article of clothing having that attribute value. Utilizing the location-dependent attributes and user sentiment regarding values for those attributes, the system can make recommendations to clothing designers or manufacturers regarding what the value of the attribute should be in order to provide an article of clothing that would be well received within the geographical region.

Such a system provides a technical improvement over current systems for clothing design. The described system and method identifies location dependent clothing characteristics or attributes. These attributes are those attributes whose value varies across geographical regions. In other words, people in one geographical region prefer one value for the characteristic, while people within a different geographical region prefer a different value. Utilizing customer reviews and historical information, the system can estimate what location-dependent attributes values will likely be popular within a particular geographical region. The system can then provide recommendations to the clothing designers or manufacturers regarding the location-dependent attributes and the values that should be selected for those attributes. Utilizing these recommendations, the clothing designers and manufacturers can design and produce pieces of clothing for specific geographical regions that are more personalized to the people of the geographical region and more likely to result in the sale of the clothing, thereby reducing waste associated with unsold clothing.

FIG. 1 illustrates a method for recommending parameter values for attributes of a clothing design based upon the geographical region in which the clothing design is introduced, by identifying location-dependent characteristics of the clothing design. At 101, the system receives a clothing design, for example, from a clothing designer or manufacturer, for an article of clothing (e.g., shirt, socks, trousers, jeans, skirt, dress, vest, tie, etc.). The clothing design may identify different attributes, characteristics, or aspects of the article of clothing. For example, the clothing design may identify the size of different components (e.g., collar, sleeve length, skirt length, tie width, etc.), the type of fabric (e.g., leather, cotton, synthetic, etc.), the fabric texture (e.g., snakeskin, feathers, smooth, etc.), the fabric design (e.g., stripes, polka-dots, floral, solid color, etc.), the fit of the article of clothing (e.g., loose fit, tight fit, athletic fit, etc.), the shape of the article of clothing (e.g., close-fitting, poufy, pleated, etc.), the primary color, whether there are decorations (e.g., flowers, ruffles, chains, pockets, etc.), an overall design inspiration, and the like.

Receipt of the clothing design may be via different modalities. For example, the clothing design may be received via a textual design description, an auditory designer interview, an image of the design, a combination thereof, or the like. Depending on how the clothing design is received, the system may utilize different attribute extraction techniques to extract the attributes. For example, if an image is received, the system may use an image analysis technique to parse the image and extract different attributes of the clothing design. The image analysis technique may be a technique that is trained for clothing design attribute extraction. In other words, when parsing the image, the technique may be specifically programmed to extract clothing design attributes as opposed to other objects or features that may be included within the image. As another example, if a designer interview or other auditory conversation or communication regarding the design is received, the system may use a natural language processing technique to extract the attributes. As with the image analysis technique, the natural language processing technique may be specifically programmed for clothing attribute extraction, thereby discarding any audio that is not related to clothing attributes. Example natural language processing techniques include topic modelling, text annotation, and the like. Corresponding analysis techniques may be used for the different modalities, for example, a text analysis technique for text-based inputs, a video analysis technique for video-based inputs, and the like.

From the received design, the system can identify different attributes of the clothing design. The system can also identify if any of these attributes are focus attributes. A focus attribute is an attribute that the designer or someone else determines to be critical to the design. In other words, these attributes are those attributes which are critical to the design and should not be varied since otherwise the overall design of the target article of clothing would be lost. For example, if a dress has a dramatic collar, the designer may feel that the collar is a critical feature of the design and if the collar was modified, the overall aesthetic of the design would be lost. Determining if an attribute is a focus attribute may include utilizing a sentiment focus extraction technique to extract, from the design input information, attributes that are highlighted or featured. In other words, if within a designer interview, the designer discusses the dramatic collar on the dress and focuses on this attribute, the system may determine that this is a focus attribute. Attributes that are not identified as focus attributes are classified as non-focus attributes. The non-focus attributes may be modified without losing the overall aesthetic, overall feel, or purpose of the design.

In addition to the clothing design, the system may access, at 102, a plurality of information sources that have sentiments of people regarding different attributes of pieces of clothing. The term sentiment is being used here throughout for ease of readability. However, this term is not limited to only an attitude or opinion of a person regarding the attribute. Rather, the term sentiment can include an attitude or opinion of a person with regards to the attribute, a comment without an attitude or opinion with regards to the attribute, sales numbers related to clothing pieces with a particular attribute, or the like. In other words, the term sentiment is used to capture any comment or indicator with respect to an attribute, regardless of whether the comment identifies an attitude or opinion regarding the attribute. From the comments or indicators, the system can determine whether the attribute is positively received or negatively received. Example information sources include customer reviews, magazine articles, other designer commentary, fashion critic reviews, social media posts, reports from fashion events, sales reports for particular clothing pieces and geographical regions, and the like. For example, a person may buy an article of clothing and post a picture of themselves in the article of clothing on social media. The person could additionally provide a text post with the picture post describing what they like about the clothing, that it is a favorite article of clothing, or the like. Other people “liking” or commenting on the post can then be used as additional information sources.

The information sources may be directed towards the target article of clothing (i.e., the article of clothing that the clothing design corresponds to), or towards pieces of clothing that are similar to each other, or that have attributes similar to the target article of clothing. For example, if the clothing design is a brand-new design, the system may identify articles of clothing that have attributes similar to the target article of clothing. The similarity may be determined using one or more similarity detection techniques, for example, similarity distance techniques, feature vectors, cosine similarity, or the like.

Based upon identifying that an article of clothing has attributes similar to the target article of clothing (“similar article of clothing”), the system may access information sources that correspond to this article of clothing. Knowing that the similar article of clothing may not have a design similar to the target article of clothing, the system may parse the information sources to extract the information within the information source that corresponds to the similar attribute(s), and only the similar attribute(s). For example, if the attribute of the similar article of clothing that is similar to the attribute of the target article of clothing is the fabric design, and the information source includes a review regarding the fabric color, the system may discard the information related to the fabric color. The system parses the information sources, either those directed towards the target article of clothing or those directed towards pieces of clothing having similar attributes, to extract sentiments of people regarding the attributes. The system can use a sentiment analysis technique, for example, a text sentiment analysis technique, video sentiment analysis technique, or other sentiment analysis technique that corresponds to the modality of the information source, to extract the sentiments and determine a feel or polarity of the sentiment (e.g., positive, negative, neutral, etc.). The system can then classify the sentiments into the different sentiment polarities, for example, positive sentiments and negative sentiments.

Each of the information sources has an associated or corresponding geographical location. The associated or corresponding geographical location is the geographical location associated with the sentiment, for example, a physical location of the user providing the sentiment, a location identified in the information source, or the like. It should be noted that the user does not have to be located within a particular geographical location that is associated with the sentiment. Rather, the user may be providing the sentiment on behalf of a particular geographical location. For example, if a fashion critic, who is physically located in Paris, provides a review indicating that people located in a particular geographical location that is not Paris would likely love the bright colors of the design, the geographical region that would correspond to, or be associated with, the sentiment would be the particular geographical region and not Paris. On the other hand, the geographical location may be the physical location of the user providing the sentiment. For example, the geographical location corresponding to a review provided by a purchaser may be the physical location of the reviewer. On the other hand, the geographical location corresponding to the review may be the geographical location where the product was purchased, which may be different than the physical location of the person providing the review.

Utilizing the geographical locations corresponding to the sentiments, the system groups the information sources into one of a plurality of geographical regions or areas. Determining the regions or areas for grouping may be based upon historical information that indicates people from certain geographical locations having sentiments that are similar to those of other geographical locations. In other words, those geographical locations that have similar sentiments with respect to an attribute value may be grouped together in one geographical area. Alternatively, the geographical regions may be traditional geographical regions, for example, within the United States, the Northeast, the South, the Midwest, and the like. All of the information sources from geographical locations located within the geographical regions may be grouped.

At 103, the system may determine whether attributes are location-dependent attributes. A location-dependent attribute is an attribute whose sentiment varies across geographical regions. In other words, the polarity of the sentiment with respect to an attribute value varies across different geographical regions. The location-dependent attributes are only identified from those attributes that were classified as non-focus attributes. In other words, attributes classified as focus attributes are not analyzed to determine if they are location-dependent attributes, because, as stated above, these attributes should not be modified in order to prevent losing the desired overall design of the target article of clothing.

Thus, to determine if an attribute, specifically, a non-focus attribute, is a location-dependent attribute (LDA), the system analyzes the sentiment regarding an attribute value across the geographical regions. If there is variation in the polarity, or feel, of the sentiment with respect to an attribute across geographical regions, this attribute is considered a location-dependent attribute. For example, if in one geographical region the people have a positive sentiment towards stripes and a negative sentiment towards polka-dots, which would be considered a fabric design attribute, and in a different geographical region the sentiment polarity is reversed, the fabric design is considered a location-dependent attribute. If there is no variation in polarity across geographical regions with regard to an attribute and the attribute is a focus attribute, the system may consider these attributes prominent attributes.

If an attribute is determined to not be a location-dependent attribute at 103, the system may classify the attribute as a non-location-dependent attribute or, alternatively, as a prominent attribute, if the attribute is also a focus attribute, at 105. If, on the other hand, the attribute is determined to be a location-dependent attribute at 103, the system may classify the attribute as a location-dependent attribute at 104. The system may then provide recommendations for parameter values for the attributes based upon the geographical region in which the target article of clothing will be sold, also referred to as the targeted geographical region. The recommendation may include recommending parameter values for attributes by correlating the targeted geographical region with the location-dependent attributes having positive sentiments within the targeted geographical region. In other words, the system may determine which location-dependent attributes and values for those attributes have a positive sentiment among people within the geographical region in which the target article of clothing is to be sold. As an example, if within a targeted geographical region, a parameter value “feathers” for the attribute “fabric texture” has positive sentiment, the system may recommend a parameter value of “feathers” for the target article of clothing.

To make the recommendations, the system may utilize a machine-learning technique that learns how attribute correlations affect sentiments of people within a particular geographical region. The machine-learning model may make predictions regarding recommendations for location-dependent attributes that vary across locations, utilizing historical data that indicate the sentiments of people within the geographical region with respect to an attribute value and with respect to an attribute value in view of other attribute values. In other words, while people may like a floral skirt, they may not like the same floral pattern for a shirt. Thus, other attributes may affect the sentiment of the people within the geographical region. As predictions are made and reviews are received, the machine-learning model takes this information as input to make more accurate predictions regarding subsequent predictions, thereby becoming more accurate over time.

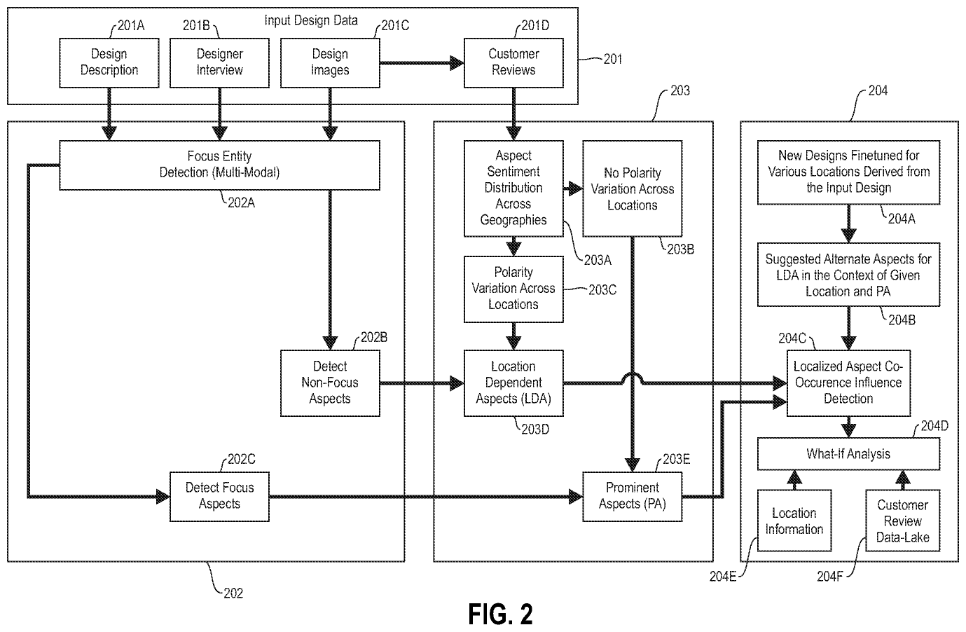

FIG. 2 illustrates an overall system architecture for the described system. Input design data 201 is received by the system. The input design data 201 may include a design description 201A, a designer interview 201B, design images 201C, or the like. The input design data 201 may also include customer reviews 201D which may correspond to the target article of clothing, or an article of clothing having at least one attribute similar to the target article of clothing. The design description 201A, designer interview 201B, design images 201C, and/or any other information related to the target clothing design may be utilized by an aspect or attribute detector 202. The aspect or attribute detector 202 utilizes a focus entity detection (multi-modal) component 202A to detect attributes that are highlighted by the designer. These are considered focus aspects or attributes 202C. Other attributes or aspects that are not highlighted are considered non-focus aspects or attributes 202B.

The customer reviews 201D and other information sources are utilized by a sentiment analysis module 203. The sentiment analysis module 203 detects an overall sentiment of people with respect to an attribute value across different geographical regions or locations 203A. If the variation in polarity of the sentiment is below a predetermined threshold, which may be a default threshold, set by a user, or the like, with respect to an attribute 203B and the attribute is considered a focus attribute 202C, the attribute is classified as a prominent attribute or aspect 203E. If, on the other hand there is a polarity variation in the sentiment across the geographical locations with respect to the attribute 203C and the attribute is considered a non-focus attribute 202B, the attribute is classified as a location dependent aspect or attribute 203D.

To generate recommendations with respect to attributes, the system utilizes a recommendation engine 204. The recommendation engine 204 fine tunes the target clothing design for various geographical locations 204A for attributes identified from the input design 201. The system then suggests, at 204B, alternative aspects or attributes for the location dependent aspects 203D based upon, or in the context of, a particular geographical region and the prominent aspects 203E. The system can use the location-dependent attributes 203D and prominent attributes 203E to detect the co-occurrence influence of particular attribute values on other attribute values based upon a target geographical region 204C. The system then selects alternates for the location-dependent attributes and performs an analysis to predict an overall sentiment of the people within the geographical region if the alternative attributes were utilized 204D. This analysis utilizes the location information 204E and a data-lake or database 204F that includes the sentiments of the people within the geographical region with respect to attribute values.

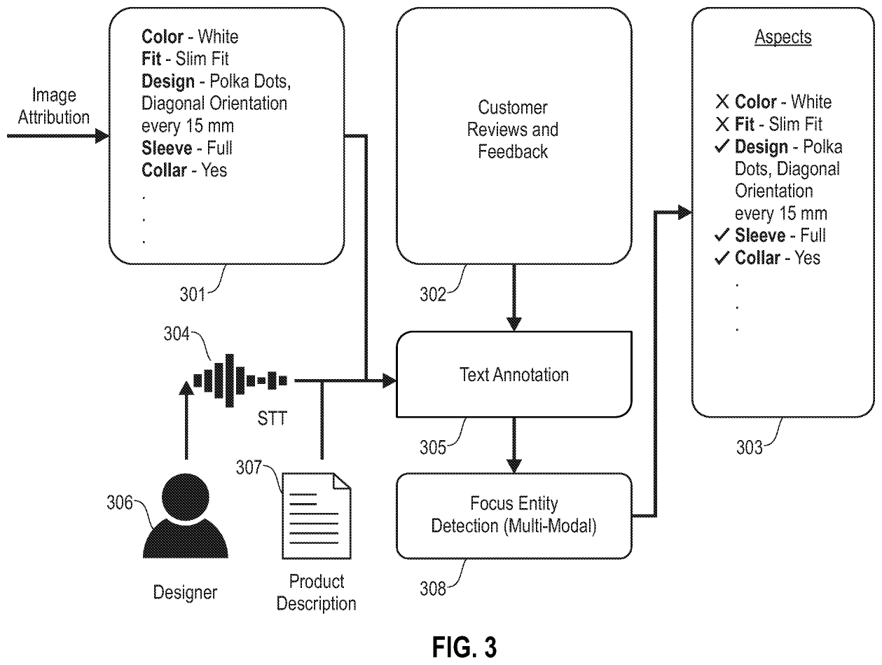

FIG. 3 illustrates an example method for identifying focus and non-focus attributes. An image or other design input is received and analyzed to extract the attributes of the design 301. The design input may include an interview 304 by the designer 306, a product description 307, an image of the design, or the like. Analysis techniques appropriate for the modality of the design input are utilized to parse the design input. The system also receives customer reviews and feedback 302 and any other information sources that may include sentiments of users with respect to the design. The parsed design input and the information sources undergo analysis, for example, text annotation 305, to detect focus entities or attributes 308. This detection 308 can be performed across modalities (e.g., text, audio, video, image, etc.). The focus entities or attributes are those that have been highlighted by the designer or otherwise indicated as being important or critical to the overall design of the target article of clothing. The result is an identification of focus and non-focus attributes or aspects 303. The aspects or attributes within box 303 that have a checkmark have been identified as focus attributes. Those with Xs have been identified as non-focus attributes.

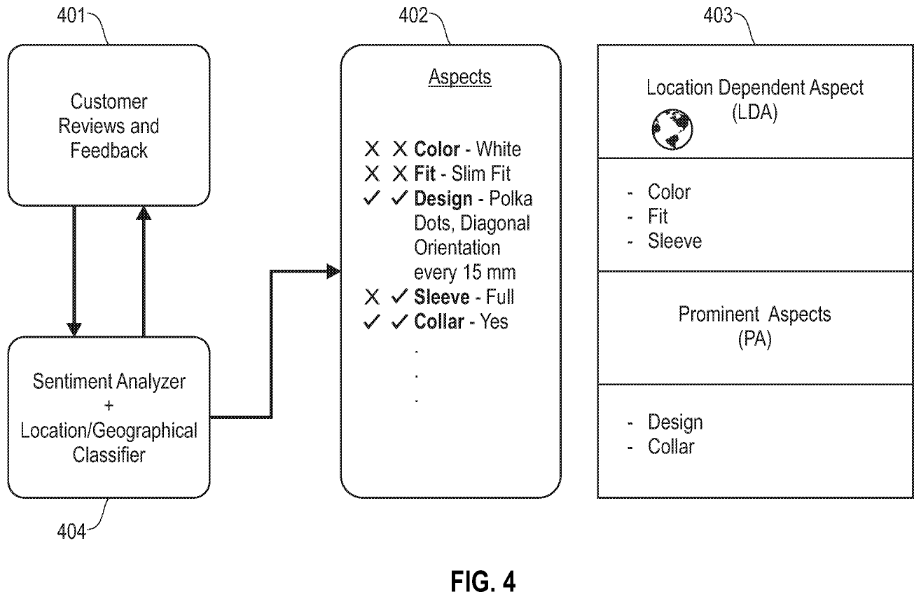

FIG. 4 illustrates an example method for identifying location-dependent attributes or aspects and prominent attributes or aspects. The aspects or attributes that have been identified as focus and non-focus attributes (box 303 of FIG. 3, not repeated in FIG. 4), may be utilized by the system to identify location-dependent attributes and prominent attributes. The system accesses customer reviews and feedback 401 and other information sources. Using a sentiment analyzer and geographical location classifier 404, the system groups the information sources into geographical areas and identifies an overall sentiment of the people within the geographical area with respect to different attributes of the design. The system then identifies those attributes where the sentiment varies across the geographical regions.

Box 402 illustrates an expanded version of box 303 of FIG. 3. The addition to box 402 is a second column of X and checkmarks. The right-hand column is the column for designation of whether the attribute is a focus or non-focus attribute, and the left-hand column is the column for designation of whether the sentiment with respect to the attribute varies across geographical areas. The checkmarks in the left-hand column designate no sentiment variation, while the Xs designate variation in sentiment across geographical regions. From these designations 402 the system can identify location-dependent attributes or aspects and prominent attributes or aspects 403. The attributes that are both focus attributes and have no sentiment variation, meaning checkmarks in both columns, are considered prominent attributes. All other attributes are considered location-dependent attributes. It should be understood that FIG. 3 and FIG. 4 provide an illustration for understanding how the different attribute types are identified. However, in practice the system may not make visualized columns, may utilize different formats, or may otherwise vary.

The system may also build a regression model based upon the different attributes. Each information source is represented as a set of features, where each feature corresponds to an attribute extracted from the information source. The information source also has an associated sentiment or polarity. The features and sentiment are utilized to build the regression model that is then used to capture attribute correlation effects on location sentiment. The recommendations may only be made for attributes that are non-focus attributes. However, the recommendations may be made in view of the prominent aspects or other focus aspects. Thus, either within the machine-learning model or within the regression model, the prominent attributes may be fixed as features, meaning these attributes cannot be varied. The regression model then selects alternative location-dependent attribute values and predicts the overall sentiment for the geographical region utilizing each of the selected location-dependent attribute values. This regression model could then be considered a predicted sales analysis. The location-dependent attribute value that results in the overall predicted sentiment of the model being the highest, reaching a predetermined threshold, or reaching a maximum, is then utilized in the recommendation for the parameter value for the location-dependent attribute.

Thus, the described systems and methods represent a technical improvement over current systems for clothing design. Currently clothing designers and manufacturers must guess regarding characteristics that may be popular within a particular geographical region. The clothing designer does not know or have a high degree of confidence regarding whether the clothing with the characteristic will be popular and sell well until the clothing piece is provided for sale. At this point, if the clothing characteristics are not popular, it is too late because the clothing has already been manufactured. Utilizing the described system and method, the clothing designer and manufacturer can be provided recommendations for clothing characteristics that should be popular within a region. The system is able to make such recommendations utilizing historical data and customer reviews, thereby identifying location-dependent characteristics that should be modified based upon the geographical region in which the clothing piece will be sold. Thus, the described system and method provide a better technique for estimating desirable and popular clothing characteristics, thereby reducing waste in unsold clothing pieces and providing a more personalized shopping experience for consumers within a particular geographical region.

As shown in FIG. 5, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving a clothing design, wherein the clothing design identifies attributes of an article of clothing;
accessing a plurality of information sources having sentiments regarding attributes of pieces of clothing, wherein each of the plurality of information sources has a corresponding geographical location associated with the sentiment, wherein each of the plurality of information sources is assigned to one of a plurality of geographical regions;
identifying, utilizing the plurality of information sources corresponding to respective assigned geographical regions, location-dependent attributes of the pieces of clothing, wherein the location-dependent attributes comprise clothing attributes whose corresponding user sentiments vary across at least a subset of the geographical regions; and
recommending, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

2. The method of claim 1, wherein the receiving comprises receiving an image corresponding to the clothing design; and
wherein the attributes are identified utilizing an image analysis technique to extract the attributes.

3. The method of claim 1, wherein the receiving comprises receiving a conversation corresponding to the clothing design; and
wherein the attributes are identified utilizing a natural language processing technique to extract the attributes from the conversation.

4. The method of claim 1, wherein the identifying the sentiments in the information sources comprises using a text sentiment analysis technique and classifying the sentiments into positive sentiments and negative sentiments.

5. The method of claim 1, wherein the recommending is made in view of attributes identified as prominent attributes, wherein the prominent attributes of the article of clothing are not varied across targeted geographical regions.

6. The method of claim 5, wherein the prominent attributes are identified as attributes (i) whose corresponding user sentiments have a variation in sentiment below a predetermined threshold across the geographical regions and (ii) being a featured characteristic of the clothing design.

7. The method of claim 1, wherein the attributes of the clothing utilized for recommendation are non-focus attributes, wherein a non-focus attribute comprises an attribute that is not critical to the design of the article of clothing.

8. The method of claim 1, wherein the recommending comprises (i) performing a plurality of predicted sales analyses, wherein each of the plurality of the predicted sales analyses utilizes a different parameter value for the attributes and (ii) recommending a parameter value for an attribute based upon the plurality of predicted sales analyses.

9. The method of claim 1, wherein the recommending comprises identifying an attribute correlation based upon the sentiment for a particular geographical region by utilizing a regression model, wherein the regression model is built from (i) the attributes and (ii) sentiments associated with the attributes.

10. The method of claim 1, wherein at least one of the plurality of information sources comprises a customer review of at least one piece of clothing having a similarity to the article of clothing.

11. An apparatus, comprising:
at least one processor; and
a computer readable storage medium having computer readable program code embodied therewith and executable by the at least one processor, the computer readable program code comprising:
computer readable program code configured to receive a clothing design, wherein the clothing design identifies attributes of an article of clothing;
computer readable program code configured to access a plurality of information sources having sentiments regarding attributes of pieces of clothing, wherein each of the plurality of information sources has a corresponding geographical location associated with the sentiment, wherein each of the plurality of information sources is assigned to one of a plurality of geographical regions;
computer readable program code configured to identify, utilizing the plurality of information sources corresponding to respective assigned geographical regions, location-dependent attributes of the pieces of clothing, wherein the location-dependent attributes comprise clothing attributes whose corresponding user sentiments vary across at least a subset of the geographical regions; and
computer readable program code configured to recommend, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

12. A computer program product, comprising:
a computer readable storage medium having computer readable program code embodied therewith, the computer readable program code executable by a processor and comprising:
computer readable program code configured to receive a clothing design, wherein the clothing design identifies attributes of an article of clothing;
computer readable program code configured to access a plurality of information sources having sentiments regarding attributes of pieces of clothing, wherein each of the plurality of information sources has a corresponding geographical location associated with the sentiment, wherein each of the plurality of information sources is assigned to one of a plurality of geographical regions;
computer readable program code configured to identify, utilizing the plurality of information sources corresponding to respective assigned geographical regions, location-dependent attributes of the pieces of clothing, wherein the location-dependent attributes comprise clothing attributes whose corresponding user sentiments vary across at least a subset of the geographical regions; and
computer readable program code configured to recommend, based upon the location-dependent attributes and a targeted geographical region in which the article of clothing is to be sold, parameter values for the attributes of the article of clothing, wherein the recommending comprises correlating (i) the targeted geographical region with (ii) location-dependent attributes having a positive sentiment within the targeted geographical region.

13. The computer program product of claim 12, wherein the receiving comprises receiving an image corresponding to the clothing design; and
wherein the attributes are identified utilizing an image analysis technique to extract the attributes.

14. The computer program product of claim 12, wherein the receiving comprises receiving a conversation corresponding to the clothing design; and
wherein the attributes are identified utilizing a natural language processing technique to extract the attributes from the conversation.

15. The computer program product of claim 12, wherein the identifying the sentiments in the information sources comprises using a text sentiment analysis technique and classifying the sentiments into positive sentiments and negative sentiments.

16. The computer program product of claim 12, wherein the recommending is made in view of attributes identified as prominent attributes, wherein the prominent attributes of the article of clothing are not varied across targeted geographical regions, wherein the prominent attributes are identified as attributes (i) whose corresponding user sentiments have a variation in sentiment below a predetermined threshold across the geographical regions and (ii) being a featured characteristic of the clothing design.

17. The computer program product of claim 12, wherein the attributes of the clothing utilized for recommendation are non-focus attributes, wherein a non-focus attribute comprises an attribute that is not critical to the design of the article of clothing.

18. The computer program product of claim 12, wherein the recommending comprises (i) performing a plurality of predicted sales analyses, wherein each of the plurality of the predicted sales analyses utilizes a different parameter value for the attributes and (ii) recommending a parameter value for an attribute based upon the plurality of predicted sales analyses.

19. The computer program product of claim 12, wherein the recommending comprises identifying an attribute correlation based upon the sentiment for a particular geographical region by utilizing a regression model, wherein the regression model is built from (i) the attributes and (ii) sentiments associated with the attributes.

20. A method, comprising:
receiving input related to a clothing design, wherein the input identifies characteristics of the clothing design;
accessing reviews of customers corresponding to the clothing design, wherein each of the reviews identifies at least one sentiment of a user providing the review regarding a characteristic of the clothing design, wherein each of the reviews is associated with a geographical location of the user providing the review and wherein the reviews are grouped into geographical areas based upon the geographical location associated with the reviews;
identifying (i) prominent characteristics of the clothing design and (ii) location-dependent characteristics of the clothing design;
wherein the identifying prominent characteristics comprises identifying characteristics of the clothing design (iii) whose corresponding user sentiments have a variation in sentiment below a predetermined threshold between geographical areas and (iv) include characteristics critical to the clothing design;
wherein the identifying location-dependent characteristics comprises identifying characteristics of the clothing design (v) whose corresponding user sentiments within one geographical area vary from corresponding user sentiments within a different geographical area and (vi) that are not critical characteristics to the clothing design; and
recommending an attribute value for the location-dependent characteristics based upon attribute values having a positive sentiment within a targeted geographical area in which the clothing design is to be sold.
